(19) United States
(12) Patent Application Publication
(10) Pub. No.: US 2004/0264700 A1
(43) Pub. Date: Dec. 30, 2004

(54) Wireless bridge device for secure, dedicated connection to a network

(75) Inventor: Dustin Kirkland, Austin, TX (US)

Correspondence Address: Joseph P. Lally, DEWAN & LALLY, L.L.P., P.O. Box 684749, Austin, TX, 78768-4749, US

(73) Assignee: International Business Machines Corporation, Armonk, NY

(21) Appl. No.: 10/607,515

(22) Filed: Jun. 26, 2003

(51) Int. Cl. H04K 1/00

(52) U.S. Cl. 380/270

(57) ABSTRACT

A data processing configuration in which a data processing system communicates with a network medium via a wireless transmission link provided by a wireless bridge device pair. The pair includes first and second wireless bridge devices having connectors suitable for connecting to the network port of the data processing system and a wall jack or router jack connected to the LAN. The bridge devices share a common encryption key that is unique to the device pair. Each device implements the wireless link transparently to the data processing system. Each wireless bridge device is configured to receive an Ethernet packet and encrypt the packet with a strong and unique encryption algorithm or key. The bridge device might add additional protocol processing to ready the packet for wireless transmission according to the wireless transmission protocol employed by the device pair.

### BACKGROUND

1. Field of the Present Invention

The present invention is in the field of data processing networks and more particularly in data processing networks that include wireless connections to network devices.

2. History of Related Art

Wireless networks and, specifically, wireless local area networks (LANs) are now prevalent in a wide variety of applications and environments. In a wireless network, two or more devices communicate by transmitting and receiving high frequency radio signals. Security is a principal concern in the design and use of wireless networks because the wireless signals propagate to any receiver, authorized or not, within range of the wireless signal transmitter. Thus, users that are unauthorized and virtually undetectable may transmit and receive the wireless signals to intercept information and/or use the wireless networks as a means for accessing the network thereby draining bandwidth from authorized users. Despite the security issues inherent in wireless communication, however, the convenience of wireless implementations is highly valued. Specifically, wireless connections eliminate unsightly and often cumbersome wired connections that constrain the placement of network devices. It would therefore be desirable to implement a wireless communication system that addressed the security concerns of conventionally implemented wireless LANs.

### SUMMARY OF THE INVENTION

The identified objective is achieved by a data processing configuration according to the present invention in which a data processing system communicates with a network medium, such as a wired Ethernet LAN, via a wireless transmission link between the system and the medium. The transmission link is achieved with a mated pair of wireless bridge devices. The mated pair includes first and second wireless bridge devices that each include connectors suitable for connecting to the Ethernet (or other network) ports of the data processing system and a wall jack or router jack connected to the LAN. The mated pair share a common encryption/decryption key that is unique to the device pair. The pair includes sufficient hardware and software to implement the wireless link in a manner that is transparent to the data processing system such that the system does not require drivers installed or any other form of modification. Each wireless bridge device is configured to receive an Ethernet packet and encrypt the packet with a strong and unique encryption algorithm or key. The bridge device might add additional protocol processing to ready the packet for wireless transmission according to the wireless transmission protocol employed by the device pair. Conversely, each bridge device is also a wireless receiver, with facilities to decode the wireless protocol and extract the encrypted data, and a decryption unit to convert the data back to a form useable by the system.

### BRIEF DESCRIPTION OF THE DRAWINGS

Other objects and advantages of the invention will become apparent upon reading the following detailed description and upon reference to the accompanying drawings in which:

FIG. 1 is a diagram of selected elements of a conventional wireless LAN configuration;

FIG. 2 is a block diagram of selected elements of a wireless data processing configuration according to one embodiment of the present invention emphasizing a pair of wireless bridge devices by which wireless communication is achieved; and

FIGS. 3A and 3B are block diagrams of selected elements of the wireless bridge devices of FIG. 2.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE INVENTION

Generally speaking, the invention contemplates a wireless communication assembly in which a first wireless bridge device connects to a wired port of a computing device such as a notebook computer while a second wireless bridge device connects to a port of a wired network media. Each of the mated bridge devices contains facilities to encrypt information with an encryption that is uniquely recognizable by the other bridge device. The encryption mechanism is inherent in each of the bridge devices and effectively limits each bridge device to communicate only with the other bridge device. In one implementation, an encryption key of at least 128 bits is employed to insure adequate encryption key uniqueness. When the wireless bridge devices are connected in their respective wired ports, the computing device and the network media are unaware of the wireless “gap” between them. In other words, the wireless bridge devices contain all of the hardware and software facilities required to implement the wireless communication such that, once the computing device is configured to communicate via its wired port, the wireless bridge may be installed and used transparently without engaging in activities such as installing software drivers for the device and/or configuring the device's state for its particular environment. In one implementation, power is supplied to the bridge device by an internal power source such as a battery while, in other embodiments, the bridge device uses externally supplied power via an active Ethernet connection or other means.

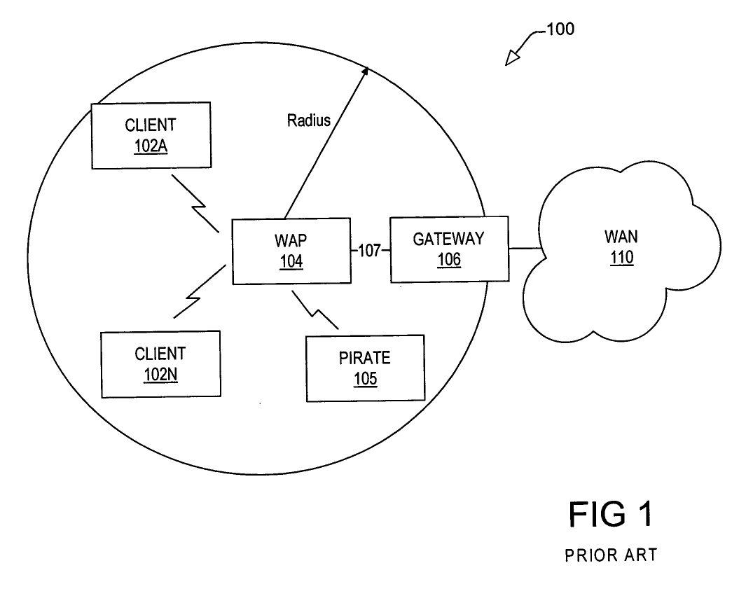

Turning now to the drawings, FIG. 1 illustrates a conventionally implemented wireless network to emphasize the associated security concerns. In the depicted embodiment, wireless network 100 includes a set of wireless client devices 102A through 102N (generically or collectively referred to herein as wireless client(s) 102). Each wireless client 102 represents some form of a data processing device such as a desktop personal computer, a notebook computer, personal digital assistant (PDA), pocket PC, paging device, and so forth. Each client 102 communicates information to and receives information from a wireless access point (WAP) 104. WAP 104 is connected to a wired network medium 107 that is connected to a wide area network (WAN) 110 such as the Internet. Network medium 107 may also connect WAP with one or more wired clients (not depicted), local area networks, and other WAP's.

WAP 104 may be compliant with a wireless LAN standard or protocol such as the Bluetooth standard or one of the IEEE 802.11 standards. In such an embodiment, WAP 104 is creates a one-to-many connection in which multiple clients 102 communicate through the WAP 104 to effectively share the bandwidth of network medium 107. In many respects, this one-to-many functionality is highly desirable and beneficial. In a typical household or small business, for example, the cost of access to a high speed embodiment of network medium 107 may limit most users to a single connection. In such cases, the household or small business can effectively share the single connection using WAP 104 and some relatively inexpensive adapter hardware.

With respect to the increasingly important considerations of network security and privacy, however, WAP 104 is the cause of significant concern. As conceptually illustrated in FIG. 1, WAP 104 has an effective range or radius, within which any suitably configured wireless adapter can unilaterally “attach” to the wireless LAN. Such unauthorized users may then send or receive network packets usually without the knowledge of authorized clients 102. Considering that many wireless adapter cards and technologies currently specify an effective range approaching 1000 feet, the potential for unauthorized users attaching to a WAP is quite great. Thus, one of the great attributes of WAP 104, the ability of connect multiple users to the network is also one of its principal drawbacks. Moreover, the configuration or setup required to implement even a simple implementation of WAP 104 is not trivial. Entire texts are dedicated to the topic of wireless LAN's and the configuration of access points with particular emphasis being placed on security.

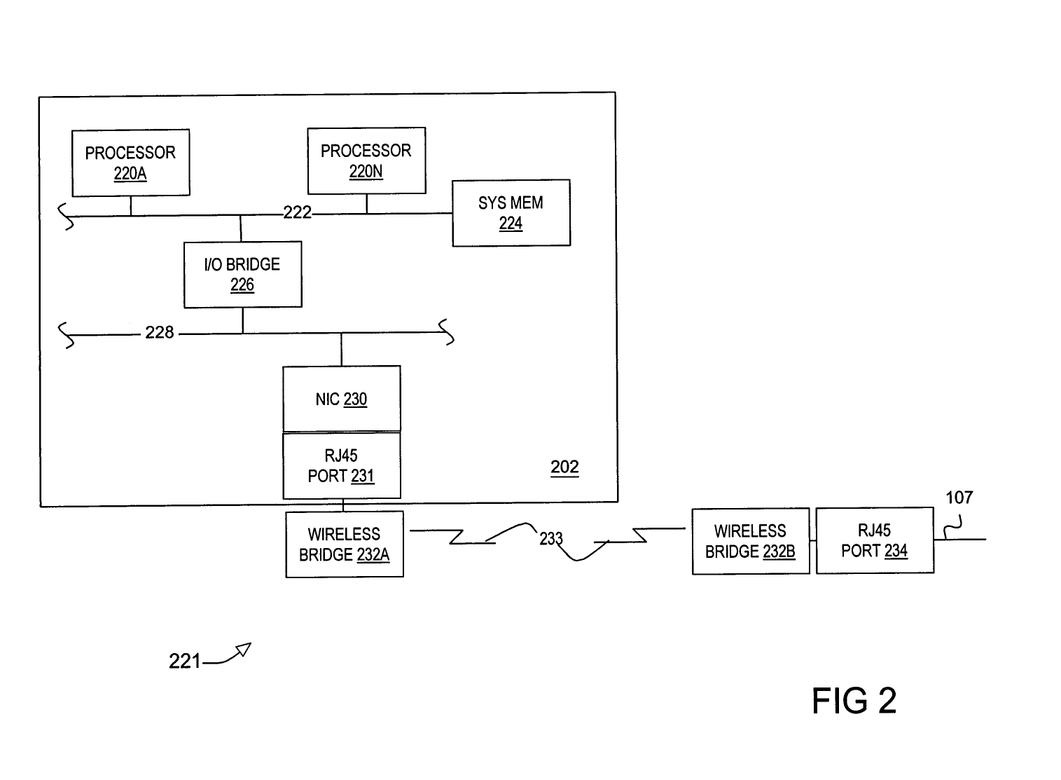

The present invention addresses the problems inherent in the one-to-many design of WAP 104 by enabling a simple wireless implementation suitable for use with a single device and a corresponding wired network port. Referring now to FIG. 2, selected elements of a wireless data processing assembly 221 according to one embodiment of the present invention are depicted. Data processing assembly 221 as depicted in FIG. 2 includes a client device 202 in the form of a microprocessor based data processing system. Client 103 includes one or more general purpose microprocessors 220A through 220N (generically or collectively referred to herein as microprocessor(s) 220) sharing a common system memory 224 over a system bus 222 in a symmetrical multiprocessing arrangement that will be familiar to those in the field of computer architecture.

An I/O bridge 226 enables peripheral devices of client 103 to communicate with processors 220 and system memory 224 one or more peripheral busses, one of which is indicated by reference numeral 228. I/O bus 228 is likely compliant with an industry standard peripheral bus such as the Peripheral Components Interface (PCI) local bus that is widely implemented and well known in the field. Among the most common type of peripheral adapters connectable to peripheral bus 228 is a network communication device, also sometimes referred to as a network interface device or NIC 230. NIC 230 likely includes a port such as an RJ-45 port for receiving a wired connector. In one embodiment desirable for its compatibility with a very large number of LAN configurations, NIC 230 is an Ethernet compliant NIC that includes a standard RJ-45 connector port 231. In a conventional wired LAN configuration, port 231 receives an RJ-45 connector through which a suitable cable, e.g., a Category 5 or CAT 5 cable as specified by the Electronics Industries Association (EIA), provides the network medium to client 103. It is worth noting for the sake of comparison that, in a conventional wireless LAN using a WAP 104 as shown and described with respect to FIG. 1, the LAN connection is typically implemented using a wireless adapter card. Such a wireless adapter card may be in the form of a PCI, PCMIA or other suitable adapter type. Regardless of its form factor, a conventional wireless adapter is a distinct device that is different than and unconnected to NIC 230.

Data processing assembly 221 according to the present invention includes a pair of wireless bridge devices 232A and 232B. In the depicted embodiment, wireless bridge 232A is connected to the RJ-45 port 231 of NIC 230 while the companion wireless bridge 232B is connected to an RJ-45 connector port or jack 234 that is likely located within a router or other network device or within a wall of an office or home. RJ-45 jack 234 is connected to a wired network 107 and, as its name suggests, is suitable for receiving the RJ-45 connector of a CAT 5 or other suitable cable.

According to the present invention, a dedicated, secure, and wireless communication line (conceptually represented by reference numeral 233) is established between client 202 and network medium 107 using the pair of wireless bridge devices 232A and 232B. In one embodiment, wireless bridge devices 232A and 232B are handheld devices that include RJ-45 connectors via which devices 232A and 232B may be “plugged” into ports 231 and 234. In the preferred embodiment, communication link 233 is established by merely plugging devices 232A and 232B into their respective ports assuming that appropriate sources of power are available to bridge devices 232. This preferred embodiment implies that bridge devices 232A and 232B include facilities and functionality to establish link 233 between themselves and that no additional resources, either software or hardware, are required of client 103 and network medium 107 to establish the link. In other words, if a suitable wired medium, if client 103 and network medium 107 are configured wherein a CAT 5 cable (not depicted) connected to ports 231 and 234 provides a wired link between client 103 and network medium 107, the cable could then be replaced by wireless bridge devices 232A and 232B to establish wireless link 233 without reconfiguration of client 103 or network medium 107.

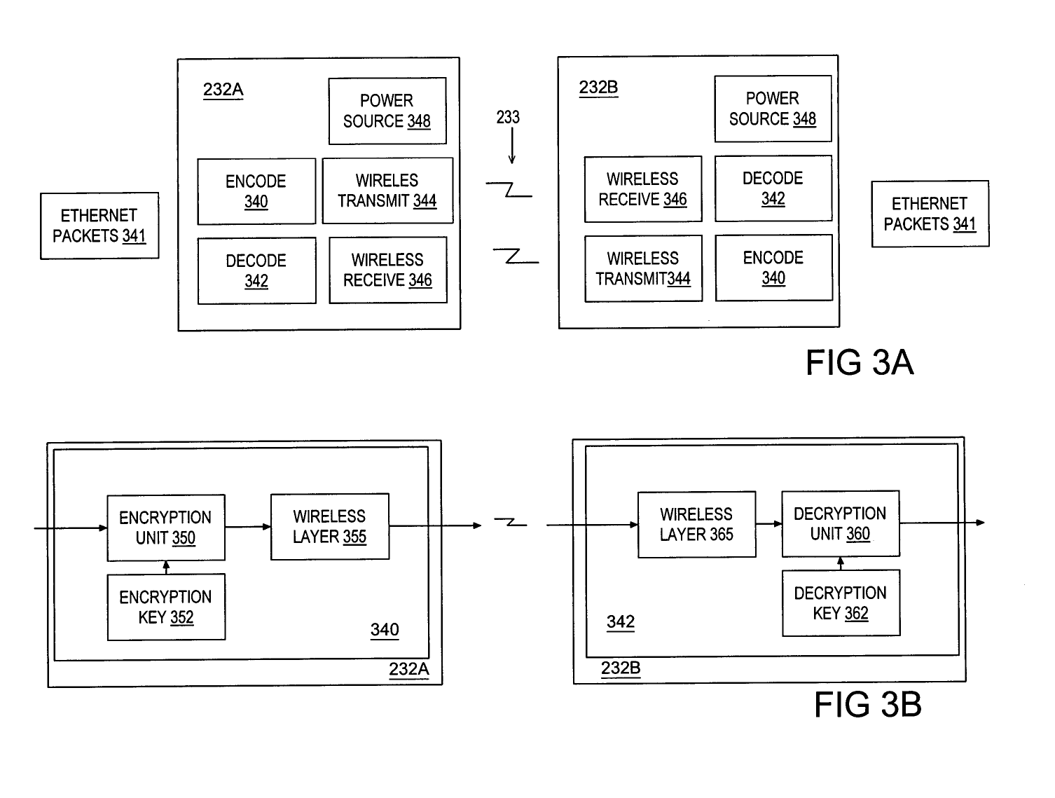

Referring now to FIGS. 3A and 3B, block diagrams of selected elements of bridge devices 232A and 232B are illustrated to emphasize functional components of the devices according to one embodiment. In FIG. 3A, each network bridge 232 includes an encoding unit 340, a decoding unit 342, wireless transmission facilities 344, and wireless receiving facilities 346. In addition, the depicted embodiment of devices 232 include an integrated power source 348. The encode units 340 are likely configured to receive network packets such as the Ethernet packets 341 illustrated. Encode units 340 are further configured in a preferred embodiment to encrypt packets 341 according to strong encryption technique.

As depicted in FIG. 3B, encode unit 340 of bridge device 232A includes an encryption unit 350 that encrypts outgoing data according to a predetermined encryption algorithm using an encryption key 352. The encrypted information is then passed to a wireless protocol layering unit 355 that formats the encrypted packet according to any of several standardized wireless protocols or according to a proprietary protocol. In one embodiment, for example, wireless protocol layering unit 355 implements a Bluetooth wireless technology and adds a corresponding protocol layer to the encrypted packet produced by encryption unit 350. The encrypted and formatted packet is then suitable for transmission via the wireless link 233 using the wireless transmit facilities indicated by reference numeral 344 of FIG. 3A. At the receiving end of wireless link 233, bridge device 232B includes protocol processing that extracts the encrypted data from each incoming packet and forwards the encrypted packet to a decryption unit 360. Decryption unit 360 uses a decryption key 362 that is matched to the encryption key 352 of wireless bridge 232A to decode incoming packets. Importantly, the encryption/decryption keys 352/362 of each pair of bridge devices 232A and 232B is unique to that bridge pair. Thus, the wireless bridge devices in a device pair 232A/232B are designed to communicate with each other exclusively. In one embodiment, the encryption/decryption keys 352/362 in are static and physically encoded or burned into encode and decode units 340 and 342. In other embodiments, the wireless bridge pair 232A/232B alters the encryption keys in use from time to time either automatically or upon request. In such embodiments, a strong authentication algorithm verifies the encryption keys after each key change to ensure that the bridge pair 232A/232B is capable of communicating with each other at all times.

The depicted embodiment of bridge devices 232A and 232B include a power source 348. to operate transmit and receive units 344 and 346. In an embodiment used in conjunction with an Ethernet network, conventional Ethernet signals do not provide a source of power. Thus, in one embodiment, each power source 348 are implemented as a battery or DC adapter integrated into the corresponding wireless bridge 232. In an alternative embodiment, wireless bridge 232 is a Power-Over-Ethernet (POE) compliant device that receives its power source from the Ethernet cabling. In a POE configuration, an “injector” (not depicted) is used to provide a DC voltage supply via one or more of unused wires in an Ethernet compliant cable. Wireless bridge 232B, which is connected to the Ethernet cable, can therefore receive its power from the cable in a POE embodiment (also referred to as active Ethernet). This configuration would enable a wireless bridge design in which the power source 348 is removed thereby reducing its cost and size. For the wireless bridge device 232A, which is not connected to CAT 5 or other Ethernet compliant cabling, power may be provided by NIC 230 through its RJ-45 connector port. In this embodiment, NIC 230 would inject a DC supply voltage onto one of the unused RJ-45 connector port wires in a manner analogous to the POE injection of a DC voltage onto the Ether cabling. In this embodiment, the NIC would preferably include some form of jumper cable, DIP switch, external switch, or software switch enabling the device to toggle between a “POE” NIC configuration and a standard NIC configuration, in which the NIC does not drive a DC voltage onto the RJ-45 wires.

It will be apparent to those skilled in the art having the benefit of this disclosure that the present invention contemplates a mechanism for securing a pair of mated cable connectors. It is understood that the form of the invention shown and described in the detailed description and the drawings are to be taken merely as presently preferred examples. It is intended that the following claims be interpreted broadly to embrace all the variations of the preferred embodiments disclosed.

What is claimed is:

1. A data processing configuration, comprising:
a data processing system;
a network communication device of the data processing system enabling the system to communicate with a network, wherein the communication device provides a port suitable for receiving a network cable connector;
a first wireless bridge device having a connector suitable for insertion in the port, wherein the wireless bridge device is configured to encrypt information received from the system according to a predetermined encryption algorithm and to transmit the information wirelessly; and
a second wireless bridge device having a connector suitable for insertion into a network port, wherein the second wireless bridge device is configured to receive information wirelessly and to decrypt received information according to a decryption algorithm that is matched to the encryption algorithm of the first bridge device wherein the first and second wireless bridge devices communicate wirelessly with each other exclusively.

2. The configuration of claim 1, wherein the first wireless bridge device is configured to format the encrypted information according to a wireless protocol prior to transmitting it and wherein the second wireless bridge device is configured to unformat the wireless protocol prior to decrypting it.

3. The configuration of claim 2, wherein the wireless protocol is selected from an IEEE 802.11 protocol and a Bluetooth protocol.

4. The configuration of claim 2, wherein the first wireless bridge device further includes means for receiving and decrypting information transmitted by the second wireless bridge and wherein the bridge includes means for encrypting network packets and transmitting the encrypted packets.

5. The configuration of claim 1, wherein the encryption algorithm is based on an encryption key common to and embedded in the first and second wireless bridge devices.

6. The configuration of claim 5, wherein the encryption key is at least 128 bits and unique to the first and second wireless bridge devices.

7. The configuration of claim 1, wherein the first and second wireless bridge device connectors are RJ-45 compliant connectors and wherein the network communication device comprises an Ethernet compliant network interface card of the data processing device.

8. A wireless bridge suitable for use in a data processing network, comprising:
a first wireless bridge device configured to receive network packets from a network device, encrypt the packets according to an encryption algorithm, and transmit the encrypted packets wirelessly;
a second wireless bridge device configured to receive encrypted network packets from the wireless bridge device and decrypt the packets according to a decryption algorithm wherein the encryption and decryption algorithms of the first and second wireless bridge devices are unique and matched to each other wherein the first is capable of communicating information exclusively to the second device exclusively and the second devices is capable of decoding information from the first device exclusively.

9. The wireless bridge of claim 8, wherein the first device is configured to connect to a network interface card (NIC) of a data processing system.

10. The wireless bridge of claim 9, wherein the first wireless bridge device includes an RJ-45 connector suitable for connecting to an Ethernet compliant NIC.

11. The wireless bridge of claim 10, wherein the second wireless bridge device is configured to connected to an RJ-45 port of a wired local area network.

12. The wireless bridge of claim 8, wherein the first wireless bridge device is configured to format the encrypted information according to a wireless protocol prior to transmitting it and wherein the second wireless bridge device is configured to unformat the wireless protocol prior to decrypting it.

13. The wireless bridge of claim 12, wherein the wireless protocol is selected from an IEEE 802.11 protocol and a Bluetooth protocol.

14. The wireless bridge of claim 12, wherein the first wireless bridge device further includes means for receiving and decrypting information transmitted by the second wireless bridge and wherein the bridge includes means for encrypting network packets and transmitting the encrypted packets.

15. A method of enabling wireless connection between a data processing device and a local area network, comprising:
providing a first wireless bridge device configured to receive network packets from a network device, encrypt the packets according to an encryption algorithm, and transmit the encrypted packets wirelessly; and
providing a second wireless bridge device configured to receive encrypted network packets from the wireless bridge device and decrypt the packets according to a decryption algorithm wherein the encryption and decryption algorithms of the first and second wireless bridge devices are unique and matched to each other wherein the first wireless bridge device is capable of communicating information exclusively to the second device exclusively and the second devices is capable of decoding information from the first device exclusively.

16. The method of claim 15, wherein providing the first and second wireless bridge devices is further characterized as providing a first bridge device configured to format the encrypted information according to a wireless protocol prior to transmitting it and providing a second wireless bridge device configured to unformat the wireless protocol prior to decrypting it.

17. The method of claim 16, wherein the wireless protocol is selected from an IEEE 802.11 protocol and a Bluetooth protocol.

18. The method of claim 16, wherein the first wireless bridge device further includes means for receiving and decrypting information transmitted by the second wireless bridge and wherein the bridge includes means for encrypting network packets and transmitting the encrypted packets.

19. The method of claim 15, wherein the encryption algorithm is based on an encryption key common to and embedded in the first and second wireless bridge devices.

20. The method of claim 19, wherein the encryption key is unique to the first and second wireless bridge devices.
